(19) United States
(12) Patent Application Publication
(10) Pub. No.: US 2024/0139568 A1
(43) Pub. Date: May 2, 2024

(54) ELECTRONICALLY ACTIVATED SPRINKLER AIRFLOW SHIFT

(71) Applicant: Tyco Fire Products LP, Cranston, RI (US)

(72) Inventor: Christopher Grayson, Richmond, RI (US)

(73) Assignee: Tyco Fire Products LP, Cranston, RI (US)

(21) Appl. No.: 18/547,137

(22) PCT Filed: Mar. 10, 2022
(86) PCT No.: PCT/IB2022/052129

§ 371 Date: Aug. 18, 2023

Related U.S. Application Data
(60) Provisional application No. 63/186,335, filed on May 10, 2021.

(51) Int. Cl. A62C 35/68; A62C 37/36

(52) U.S. Cl. CPC A62C 35/68; A62C 37/04

(57) ABSTRACT

Fire protection systems and methods are provided. The system can include a controller communicably coupled with a detector. The controller can receive an input signal from the detector. The detector can be disposed at a location of a space. The input signal can indicate an active hazard event. The controller can determine a speed and a direction of an airflow in the space. The controller can determine an offset for the active hazard event. The offset can be based on at least one of the speed and the direction of the airflow. The controller can provide an actuation command to a sprinkler based on the input signal received from the detector and based on the offset for the active hazard event.

### CROSS-REFERENCE TO RELATED PATENT APPLICATIONS

This application claims the benefit of and priority to U.S. Provisional Application No. 63/186,335, filed on May 10, 2021, the entire disclosure of which is incorporated by reference herein.

### BACKGROUND

Fire protection systems are used to deliver fluid to a location at which a fire may be taking place. Fire protection systems can be actuated in response to trigger conditions, such as smoke or heat. Electronic fire protection systems can be actuated using an electric impulse.

### SUMMARY

At least one aspect relates to a fire protection system. The system can include a controller communicably coupled with a detector. The controller can receive an input signal from the detector. The detector can be disposed at a location of a space. The input signal can indicate an active hazard event. The controller can determine a speed and a direction of an airflow in the space. The controller can determine an offset for the active hazard event. The offset can be based on at least one of the speed and the direction of the airflow. The controller can provide an actuation command to a sprinkler based on the input signal received from the detector and based on the offset for the active hazard event.

At least one aspect relates to a method for detecting a fire. The method can include receiving, by a controller, an input signal from a detector. The detector can be disposed at a location of a space. The input signal can indicate an active hazard event. The method can include determining, by the controller, a speed and a direction of airflow in the space. The method can include determining, by the controller, an offset for the active hazard event. The offset can be based on at least one of the speed and the direction of the airflow. The method can include providing, by the controller, an actuation command to a sprinkler based on the input signal received from the detector and based on the offset for the active hazard event.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example sprinkler system.

FIG. 2 depicts an elevation view of an example fire protection system.

FIG. 3 depicts an elevation view of an example fire protection system.

FIG. 4 depicts a top view of an example fire protection system.

FIG. 5 depicts a schematic illustration of an example controller for use in a fire protection system.

FIG. 6 depicts a flow diagram of an example fire protection method.

### DETAILED DESCRIPTION

Following below are more detailed descriptions of various concepts related to, and implementations of, methods, apparatuses, and systems of fire protection. The various concepts introduced above and discussed in greater detail below may be implemented in any of numerous ways.

The present disclosure generally relates to a fire protection system. More particularly, the present disclosure relates to a fire protection system that includes determining an airflow in a space (e.g., residence, school, warehouse, factory, storage facility) so that the system can locate an event in the space and can actuate the appropriate sprinklers to respond to the event. Using the airflow in the space to locate the event ensures that the sprinklers that would be best at eliminating or containing the event (e.g., the sprinklers closest to the event) are actuated, instead of automatically actuating sprinklers nearest to the detector that sensed the event first.

Fire protection systems generally include sprinklers which are configured to inhibit or permit flow of fluid (typically water, but also in some applications fire suppressant fluid) depending upon conditions. Fire protection systems are used in various environments, including but not limited to, residences, schools, warehouses, factories, and stores. In the instance of a fire, the sprinklers are configured to permit the flow of fluid such that the fluid may be dispersed to subdue or prevent the spread of fire within a given area.

The system described herein can include various configurations. The system determines an airflow in order to determine the location of an event and actuate the appropriate sprinklers in response to the event. The sprinklers that are to actuate are determined, in part, by the speed and the direction of the airflow. A sprinkler can be told to actuate or to hold based on the location of the event.

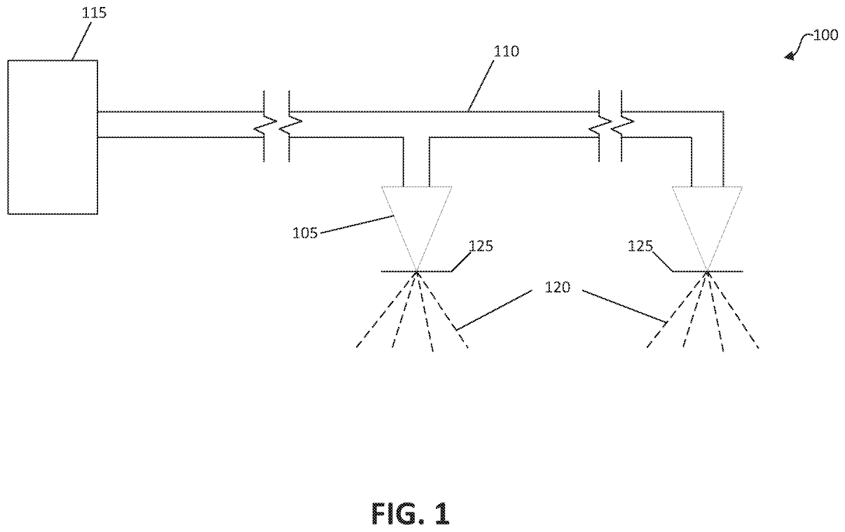

FIG. 1 depicts at least one sprinkler system 100. The sprinkler system 100 can include at least one sprinkler 105, piping 110 (e.g., one or more pipes, tubes, conduits), and at least one fluid supply 115. The sprinkler 105 can be mounted on or connected with piping 110 and can be any kind of sprinkler (e.g., electronically activated sprinkler (EAS), early suppression fast response (ESFR) sprinkler, extended coverage (EC) sprinkler). The piping 110 can include one or more main pipes, connected with the fluid supply 115, from which one or more branch lines extend. The piping 110 can be fluidly coupled with one or more sprinklers 105. The sprinklers 105 can receive water or other fire suppressant fluids 120 from the fluid supply 115 via the piping 110. The sprinklers 105 each define one or more outlets, through which the fire suppressant fluid 120 can exit and contact at least one deflector 125 to form a spray of water or other fire suppressant fluid 120 that covers a desired area. The fire suppressant fluid 120 from the sprinklers 105 then suppress or extinguish fire within that area.

The sprinkler system 100 can distribute at least one fire suppressant fluid 120 onto or nearby a fire, extinguishing the fire and preventing the fire from spreading. The sprinkler system 100 can be used to protect, among others, a storage rack assembly in a space. The sprinkler system 100 can be used alone or in conjunction with other types of fire suppression systems (e.g., other building sprinkler systems, a handheld fire extinguisher). The sprinkler system 100 can be used with a variety of fire suppressant fluids 120, including but not limited to water (e.g., powders, liquids, foams, or other fluid or flowable materials).

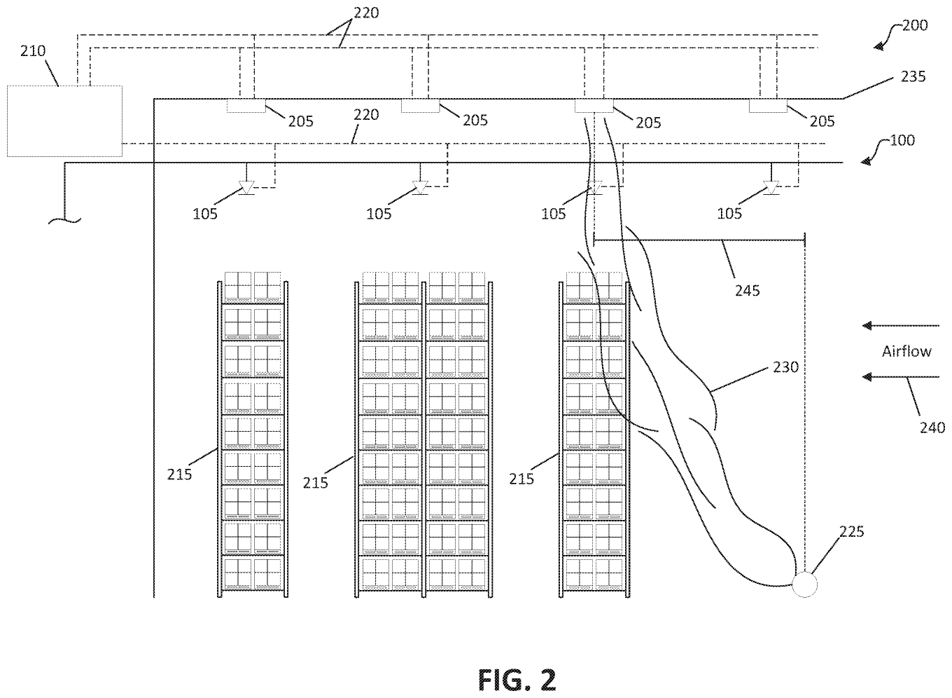

FIG. 2 depicts at least one fire protection system 200. Fire protection system 200 can include at least one sprinkler system 100, at least one detector 205, and at least one controller 210. The fire protection system 200 can be used to protect at least one storage structure 215. The storage structure 215 can include densely packed storage structures (e.g., double-deep rack, push-back rack, pallet flow rack). The storage structure 215 can include rack arrangements (e.g., single-row racks, multi-row racks) and non-rack storage systems including, for example, palletized, solid-piled (stacked commodities), bin box (storage in five-sided boxes with little to no space between boxes), shelf (storage on structures up to and including thirty inches deep and separated by aisles of at least thirty inches wide) or back-to-back shelf storage (two shelves separated by a vertical barrier with no longitudinal flue space and maximum storage height of fifteen feet).

The storage structure 215 can further include an automated storage and retrieval system (ASRS). The ASRS can be any of a number of automated storage and retrieval systems. For example, the ASRS can be a vertical carousel, horizontal carousel, vertical lift module, etc. The ASRS can be a high-piled storage system (in excess of twelve feet (12 ft)). The ASRS can be a densely packed structure comprising shafts and tracks for a computer implemented retrieval system to retrieve items or bins located throughout the structure.

The stored commodity in the storage structure 215 can include any one of NFPA-13 defined Class I, II, III or IV commodities, alternatively Group A, Group B, or Group C plastics, elastomers, and rubbers, or further in the alternative any type of commodity capable of having its combustion behavior characterized. With regard to the protection of Group A plastics, the systems and methods can be configured for the protection of expanded and exposed plastics. According to NFPA 13, Sec. 3.9.1.13, “Expanded (Foamed or Cellular) Plastics” is defined as “[t] hose plastics, the density of which is reduced by the presence of numerous small cavities (cells), interconnecting or not, disposed throughout the mass.” Section 3.9.1.14 of NFPA 13 defines “Exposed Group A Plastic Commodities” as “[t] hose plastics not in packaging or coverings that absorb water or otherwise appreciably retard the burning hazard.”

In fire protection system 200, the sprinklers 105 can be installed between a ceiling 235 of a space and the tops of the storage structures 215 as shown in FIG. 2, among others. The sprinklers 105 can be mounted or connected with the piping 110. A portion of the piping 110 can be suspended beneath the ceiling 235 of the space and above the storage structure 215 to be protected. The sprinklers 105 can be electronically activated sprinklers (EAS) that are electronically coupled with the detector 205 or the controller 210. The electronic coupling can be a wired or wireless connection. For example, the sprinkler 105 can be wired to a detector 205 to receive an actuation signal. In another example, the sprinkler 105 can be wirelessly connected (e.g., network connection, Bluetooth) to the controller 210 to receive an actuation signal. A connection 220 can be either a wired or wireless connection. The sprinklers 105 can be aligned with or coupled with the detectors 205, or the sprinklers 105 can be positioned offset from the detectors 205 in an orientation sufficient to provide adequate protection to the desired protected area. For example, sprinklers 105 can be disposed below, but remain axially aligned with the detectors 205 (as depicted in FIG. 2, among others), or the sprinklers 105 can be horizontally offset from the detectors 205. Alternatively, the sprinklers 105 and the detectors 205 can make up one structural element.

The detector 205 can be positioned near the storage structure 215 to monitor the space to detect changes for any one of temperature, thermal energy, spectral energy, smoke, and any other parameter to indicate the presence of a hazard event (e.g, a fire) in the space. With more than one detector 205, the detectors 205 can be, for example, disposed in a grid pattern with each detector 205 at a different location in the space. The controller 210 can be communicably coupled with any of the detectors 205 via at least one connection 220. When a detector 205 detects a hazard event in the space, the detector 205 can send an input signal to the controller 210 via connection 220. For example, if the detector 205 senses smoke indicative of a fire, the detector 205 can send an input signal to the controller 210. The input signal that the controller 210 receives from the detector 205 can indicate that there is an active fire in the space.

FIG. 2 depicts an example of at least one fire 225 (depicted as a circle) igniting under fire protection system 200. The fire 225 can produce smoke 230. The smoke 230 can rise in the space toward the ceiling 235. The detector 205 disposed at a location in the space can detect the smoke 230 when the smoke 230 reaches the detector 205. For example, fire 225 can be directly below a sprinkler 105 and a detector 205. The fire 225, the sprinkler 105, and the detector 205 can all be offset from the storage structure 215. Fire 225 can create smoke 230 that rises to the ceiling 235. In one example, the smoke 230 can rise straight up and reach the detector disposed directly above it. In another example, if there is an airflow 240 in the space, the smoke 230 can drift according to a speed and a direction of the airflow 240 and be detected by a different detector 205 (e.g., a detector 205 directly above the storage structure 215). The detector 205 that senses the smoke 230 can send an input signal to the controller 210 via connection 220.

When the airflow 240 is present in the space, the sprinkler 105 closest to the detector 205 that detects the fire 225 is not always the best sprinkler to extinguish or contain the fire 225. For example, in FIG. 2, the fire 225 can be offset from the storage structure 215, but the detector 205 above the storage structure 215 can be the one sensing the smoke 230. As such, it can be more beneficial for the sprinkler 105 disposed at a location offset from the storage structure (e.g., directly over the fire 225) to actuate rather than the sprinkler 105 above the storage structure 215 (closest to the detector 205) to actuate. As such, the controller 210 can determine an offset for the fire 225 that can be based, in part, on at least one of the speed and the direction of the airflow 240. For example, if the airflow 240 is five miles per hour, the controller 210 can calculate at least one distance 245 of how far the smoke 230 could have drifted before reaching the detector 205 from which the controller 210 received the input signal. The distance 245 can be a lateral distance between the fire 225 and the detector 205 that detected the smoke 230. Based on the distance 245, the controller 210 can determine an offset for the fire. The offset can determine which sprinkler 105 is the best sprinkler 105 to actuate to extinguish the fire. The offset can be defined, for example, by a distance away from the detector 205 that detected the fire 225 or by a number of sprinklers away from the detector 205 that detected the fire 225. For example, if the distance 245 is fifteen feet, the offset can be the distance to the sprinkler 105 closest to fifteen feet away from the detector 205 that detected the fire. In another example, the offset can be two sprinklers away from the detector 205. With an offset of two sprinklers away, a sprinkler 105 that is two sprinklers away from the detector 205 that detected the fire 225 is the sprinkler 105 closest to being directly above the fire. The offset can also result in multiple sprinklers 105 actuating if the location of the fire 225 is best protected by more than one sprinkler 105. For example, if the offset is determined to be fifteen feet away from the detector 205 that detected the fire 225, and a first sprinkler is ten feet away and a second sprinkler is twenty feet away, both the first and the second sprinkler can actuate to extinguish the fire 225.

In another example, if the airflow 240 is moving from right to left (as depicted in FIG. 2, among others), the controller 210 can determine whether the sprinkler 105 to the right or to the left of the detector 205 that detected the smoke 230 should actuate. Based on the direction of the airflow 240, the controller 210 can determine the offset for the fire. Again, the offset, for example, can be defined by a distance or by a number of sprinklers, and can also include in which direction the desired sprinkler 105 is disposed relative to the detector 205 that detected the fire 225. For example the offset can be fifteen feet to the right of the detector 205.

In another example, the offset can be based, in part, on a height of the ceiling 235. For example, spaces with higher ceilings give the smoke 230 more time to drift away from the area directly above the location of the fire as it rises to the ceiling 235. As such, controller 210 can also take into account the height of the space when determining the offset for the fire. For example, smoke 230 in a space with a ceiling height of thirty feet and a certain airflow speed can drift ten feet. Smoke 230 in a space with a ceiling height of sixty feet and the same airflow speed can drift twenty feet. The offset for the fire in the space with a sixty foot ceiling can be double the offset for the fire in a space with a thirty foot ceiling.

In order to determine the offset, the controller 210 can determine at least one of the speed and the direction of the airflow 240. Determining the speed and direction of the airflow 240 can include, for example, the input signal received by the controller 210 indicating at least one of the speed and the direction of the airflow 240 or the controller 210 calculating at least one of the speed or direction of the airflow 240. For example, the detector 205 that senses the smoke 230 can include a measuring device (e.g., anemometer). The measuring device can detect the speed or direction of the airflow 240 and the detector 205 can provide the speed or direction to the controller 210 via the input signal. In another example, the controller 210 can be communicably coupled with at least two detectors 205 and can receive an input signal from a first detector 205 before receiving an input signal from a second detector 205. Both input signals can indicate the fire 225 is present. The controller 210 can calculate at least one of the speed and direction of the airflow 240 by, for example, analyzing at least one of a location of the first detector 205 relative to a location of the second detector 205 and a time between receipt of the input signal from the first detector 205 and receipt of the input signal from the second detector 205. The location of the first detector 205 can be at a first location of the space and the location of the second detector 205 can be at a second location of the space. For example, to determine the direction of the airflow 240, the controller 210 can determine that the first detector is disposed at a location of the space to the right of the second detector, meaning the airflow is moving from right to left. Further, to determine the speed of the airflow 240, if the first detector 205 is, for example, fifteen feet away from the second detector 205 and the input signal from the second detector 205 is received two seconds after the input signal from the first detector 205, the speed of the airflow 240 can be calculated to be about 7.5 feet per second or about five miles per hour. The controller 210 can use the provided or calculated speed or direction of the airflow 240 to determine the distance 245 between the fire 225 and the detector 205 that detected the fire 225 and determine the appropriate offset. Once the offset is determined based on at least one of the speed of the airflow 240, the direction of the airflow 240, and the height of the ceiling, the controller 210 can send a command to a sprinkler 105.

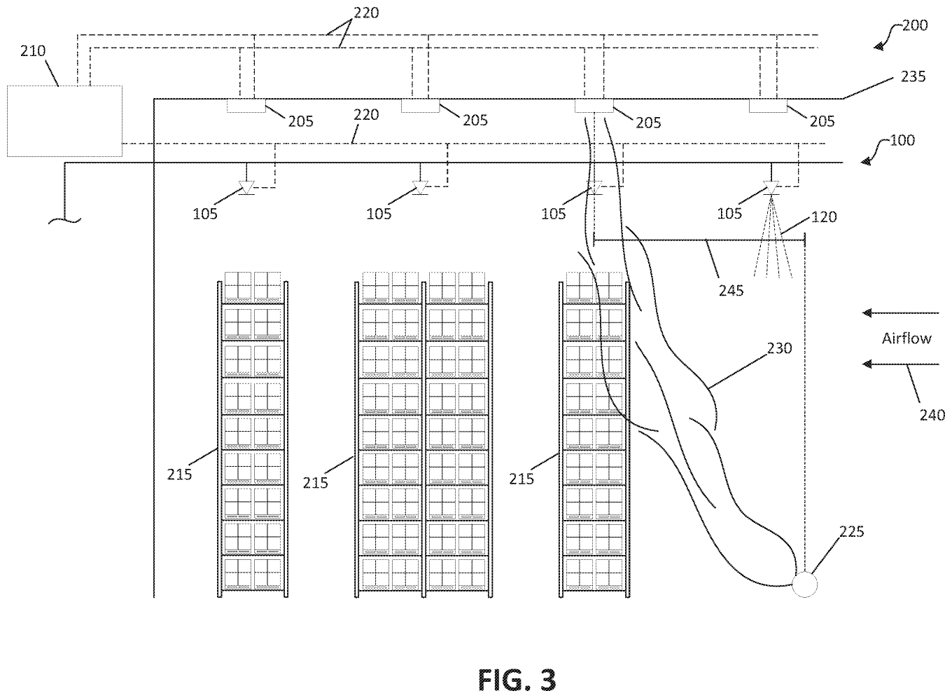

FIG. 3 depicts the fire protection system 200 with a sprinkler 105 in an actuated state. With the an input signal from a detector 205 and an offset for a hazard event, the controller 210 can provide an actuation command to a sprinkler 105. The actuation command does not need to go to the sprinkler 105 closest to the detector 205 that detected the event. For example, as depicted in FIG. 3, among others, the smoke 230 from fire 225 does not travel straight up to the ceiling 235. Instead, the smoke can travel a lateral distance 245 before reaching the ceiling 235 due to an airflow 240 in the space. With the airflow 240 shifting the trajectory of the smoke 230, the detector 205 above the storage structure 215 can detect the smoke 230 instead of the detector 205 directly above the fire 225. However, even though the detector 205 above the storage structure 215 detects the smoke 230, the controller 210 can send the actuation command to the sprinkler 105 that is not above the storage structure (e.g., to a sprinkler 105 that is not the sprinkler 105 that is the closest to the detector 205 that detected the smoke 230, but rather the sprinkler 105 closest to directly above the hazard event).

In one example, the controller 210 can bypass the sprinkler 105 closest to the detector 205 that detected the smoke 230 and provide an actuation command to a different sprinkler 105. For example, a first sprinkler 105 can be disposed a first distance away from the detector 205 that detected the smoke 230. A second sprinkler 105 can be disposed a second distance away from the detector 205 that detected the smoke 230. The second distance can be longer than the first distance. If the controller 210, for example, determines the offset to be two sprinklers away, the controller 210 can bypass the first sprinkler 105 disposed the first distance away from the detector 205 that detected the smoke 230 (e.g., provide no command to the first sprinkler 105) and provide the actuation command to the second sprinkler disposed the second distance away from the detector that detected the smoke 230. The controller 210 can also bypass several sprinklers 105 or provide actuation commands to several sprinklers 105 depending, in part, on the offset. For example, if the offset is three sprinklers away from the detector 205 that detected the smoke 230, the controller 210 can bypass a first sprinkler and a second sprinkler before providing an actuation command to a third sprinkler, the third sprinkler being disposed a distance farther away from the detector 205 than the first sprinkler and the second sprinkler.

Alternatively, instead of bypassing the first sprinkler 105 disposed at the first distance away from the detector 205 that detected the smoke 230, the controller 210 can send a hold command to the first sprinkler 105 to at least temporarily inhibit the first sprinkler 105 from actuating. The hold command can actively tell the first sprinkler 105 to remain inactive and not respond to the detected fire 225. This hold command can remain for the duration of the fire 225 or it can be overridden by a subsequent command if the controller 210 determines the first sprinkler 105 should be actuated (e.g., the fire has spread to the area below the first sprinkler 105). The controller 210 can also send the hold command to more than just the first sprinkler 105 depending, in part, on the offset. The controller 210 can send actuation commands to the appropriate sprinklers 105 before, after, or simultaneously with sending the hold commands.

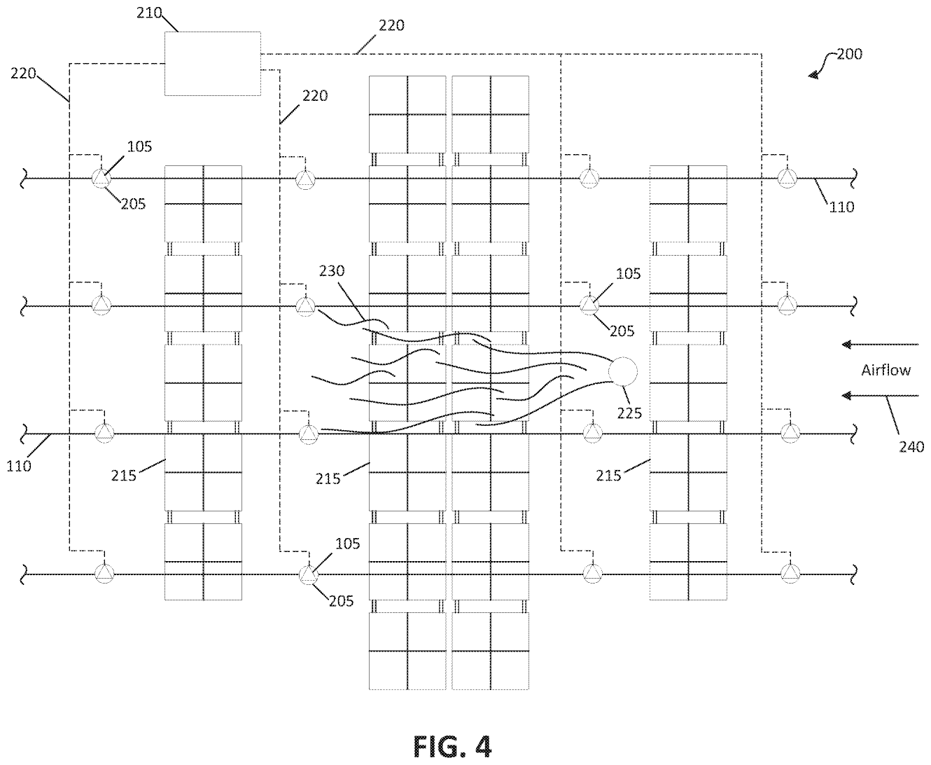

FIG. 4 depicts a top view of fire protection system 200. The fire protection system 200 can include a plurality of detectors 205 disposed in a grid pattern to monitor a storage structure 215 for a fire. For example, the detectors 205 can be disposed at different locations throughout the space, and can be spaced apart to cover all of the storage structures 215 in the space. For example, the detectors 205 can be disposed directly above the storage structures 215 (as depicted in FIG. 3, among others) or the detectors 205 can be disposed above the aisles between the storage structures (as depicted in FIG. 4, among others). The detectors 205 can be organized into straight rows or can be arranged in different patterns. The storage structure 215 can include any variety of rack arrangements or other storage formations (e.g., boxes, shelves). The grid pattern can be disposed beneath the ceiling 235 of the space and above the top of the storage structures 215 (as depicted in FIG. 3, among others). Each of the plurality of detectors 205 can be communicably coupled with controller 210 via connection 220.

The fire protection system 200 can also include a plurality of sprinklers 105 disposed in a grid pattern to protect the storage structure 215. The sprinklers 105 can be a part of an electronically activated sprinkler system. For example, similar to the detectors 205, the sprinklers 105 can be disposed at different locations throughout the space, and can be spaced part to cover all of the storage structures 215 in the space. The sprinklers 105 can be organized into straight rows or can be arranged in different patterns. Again, the storage structure 215 can include any variety of rack arrangements or other storage formations (e.g., boxes, shelves). The grid pattern can be disposed beneath the ceiling 235 of the space and above the top of the storage structures 215 (as depicted in FIG. 3, among others). The sprinklers 105 can be axially aligned with the detectors 205 (as depicted in FIG. 4, among others) or the sprinklers 105 can be offset from the detectors 205. Each of the plurality of sprinklers 105 can be communicably coupled with controller 210 or the detectors 205.

As depicted in FIG. 4, multiple detectors 205 can sense an event at the same time. For example, even with the detectors 205 at different locations within the space, smoke from a fire can disperse when rising toward the ceiling 235, reaching two different detectors 205 in two different locations in the space. Each detector can send a signal indicating the detection of the event to the controller 210. The controller 210 can respond according to the systems and methods described herein.

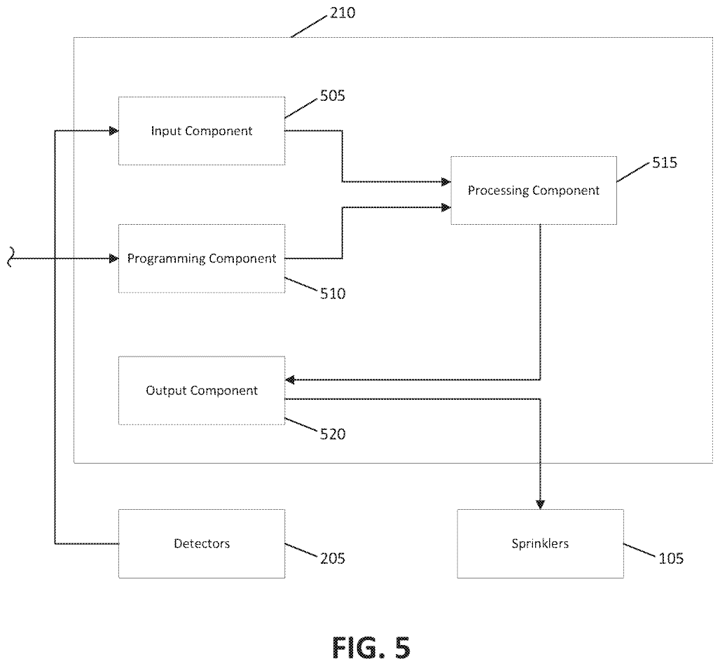

FIG. 5 depicts a schematic illustration of an example controller 210 for use in fire protection system 200. Controller 210 can be structured for receiving, processing, and generating the various input and output signals from or to each of the detectors 205 and sprinklers 105. Functionally, the preferred controller 210 includes at least one input component 505, at least one programming component 510, at least one processing component 515, and at least one output component 520. The input component 505 can receive detection data or input signals from the detectors 205. The detection data or signals can include, for example, either raw detector data or calibrated data, such as for example, any one of continuous or intermittent temperature data, spectral energy data, smoke data or the raw electrical signals representing such parameters, e.g., voltage, current or digital signal, that would indicate a measured environmental parameter of the space. Additional data parameters collected from the detectors 205 can include time data, address, or location data of the detector 205. If the detector 205 includes a measuring device (e.g., anemometer), the input component 505 can also receive other data, for example, the speed and the direction of airflow 240 in the space.

The programming component 510 can provide for input of user defined parameters, criteria, or rules that can define detection of a fire, the location of the fire, the profile of the fire, the magnitude of the fire, or a threshold moment in the fire growth. Moreover, the programming component 510 can provide for input of select or user-defined parameters, criteria, or rules to identify sprinklers 105 for operation in response to the detected fire, including one or more of the following: defining relations between sprinklers 105 (e.g., proximity, adjacency, etc.), defining limits on the number of devices to be operated (i.e., maximum and minimums, the time of operation, the sequence of operation, pattern or geometry of devices for operation, their rate of discharge), or defining associations or relations to detectors. For example, the programming component 510 can include an algorithm allowing the controller 210 to determine which sprinklers 105 to actuate when the speed of the airflow 240 is at five miles per hour and the direction of the airflow 240 is going from right to left.

Accordingly, the processing component 515 can process the input and parameters from the input component 505 and programming component 510 to detect and locate a fire, and select, prioritize, or identify the sprinklers 105 for controlled operation in a preferred manner. For example, the processing component 515 can determine when an offset is two sprinklers 105 away from a detector 205. The output component 520 of the controller 210 can generate an appropriate signal or command to control operation of the identified sprinklers 105 in accordance with one or more methodologies described herein. The programming may be hard wired or logically programmed and the signals between system components can be one or more of analog, digital, or fiber optic data. Moreover communication between components, for example connections 220, of the fire protection system 200 can be any one or more of wired or wireless communication.

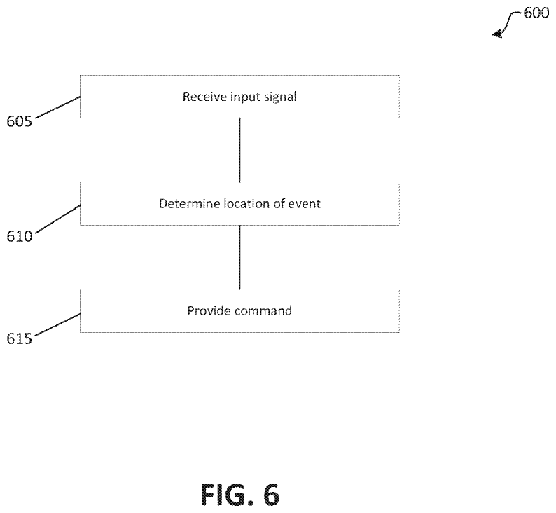

FIG. 6 depicts a flow diagram of an example fire protection method 600. Method 600 can include receiving an input signal 605, determining a location of an event 610, and providing a command 615. Act 605 can include installing a plurality of detectors 205 or a plurality of sprinklers 105. The plurality of detectors 205 can be disposed in a grid pattern to monitor a storage structure 215 for a fire. The storage structure 215 can include, for example, at least one rack arrangement. The grid pattern can be disposed beneath a ceiling 235 of a space and above the storage structure 215. The plurality of sprinklers 105 can be a part of an electronically activated sprinkler system. The sprinklers 105 can be disposed in a grid pattern to protect the storage structure 215 from a fire. The grid pattern can be disposed beneath the ceiling 235 of the space and above the storage structure 215. At least one of the plurality of detectors 205 can align axially with at least one of the plurality of sprinklers 105.

At act 605, receiving an input signal can include the controller 210 receiving a signal via an input component 505 from a detector 205 (e.g., smoke detector, temperature detector) of a fire protection system 200 indicating at least one of detection of an event, a direction of an airflow 240, a speed of the airflow 240, and a location of the detector 205 in a space. For example, the detector 205 can be a smoke detector detecting a fire 225 in a space by sensing smoke 230. The signal can include data corresponding to the detection of the smoke 230. The signal can also include data corresponding to the location of the detector 205 within the space. For example, the signal can indicate that the detector 205 that detected the smoke 230 is the detector 205 in the third row and the third column of a detector grid pattern. In another example, every detector can be given an identifier (e.g., Detector 1). The instructions provided to the controller 210 via the programming component 510 can have a location that correlates to each specific detector 205, and when a detector 205 sends a signal to the controller 210, the signal includes the identifier and the controller 210 can determine the location of that detector 205. Further, the detector 205 can include a measurement device (e.g., anemometer) that can measure the direction of airflow 240 or the speed of the airflow 240. The signal can also include data corresponding to the measured direction or speed of the airflow 240. The controller 210 can also receive signals from multiple detectors.

At act 610, determining a location of an event can include analyzing, by the controller 210 via the processing component 515, the signal received from the detector 205 to determine a location of the event in the space. Determining the location of the event can include determining a speed and a direction of the airflow 240. For example, if the signal includes the speed and the direction of the airflow 240, the controller 210 via the processing component 515 can read the input signal and collect that data. If the input signal provided to the controller 210 does not indicate the speed and the direction of the airflow 240, the controller 210 can calculate the speed and the direction of the airflow 240 from other data collected from the input signal. For example, if the detector 205 does not have a measuring device (e.g., anemometer), the detector 205 cannot provide such information. Instead, the controller 210 via instructions previously provided to the programming component 510, can calculate the speed and direction of the airflow 240 based on the relative location of multiple detectors 205 from which the controller 210 receives input signals and the time between when the input signals were received. For example, the instructions provided to the programming component 510 can include that a first detector 205 is disposed at a first location fifteen feet to the right of a second detector 205 disposed at a second location. The first detector 205 can detect smoke 230 and send a signal indicative of a fire 225 to the controller 210 two seconds before the second detector 205 detects the smoke 230 and sends another signal, also indicative of the fire 225, to the controller 210. Based, in part, on at least one of the relative locations of the first detector 205 and the second detector 205 and the time between receipt of each input signal, the controller 210 can determine the direction of the airflow 240 is right to left and the speed is 7.5 feet per second (approximately five miles per hour).

Act 610 can also include determining an offset of the event, the offset being based on a distance 245 between the location of the event and the location of the detector 205 that detects the event. The offset can be based on at least one of the speed and the direction of the airflow 240. The offset can also be based, in part, on the ceiling height of the space. For example, knowing the location of the detector 205 that detected the fire 225, either via the signal or via being calculated by the parameters previously provided to the programming component 510, the controller 210 can determine an offset between the detector 205 and the event. For example, the offset is meant to compensate for any lateral distance 245 the smoke 230 has traveled before reaching a detector 205. For example, the offset can be a distance and a direction away from the detector 205 that detected the event, or a number of sprinklers away from the detector 205 that detected the event. For example, the offset can be fifteen feet to the right of the detector 205. The offset can also be one sprinkler to the right of the detector 205. The offset can determine which sprinkler 105 is the best sprinkler 105 to actuate to extinguish the fire 225 due to the proximity of the sprinkler 105 to the fire.

At act 615, providing a command can include providing an actuation command or a hold command to at least one sprinkler. The command can be based, in part, on the input signal received from the detector 205 from act 605 and on the offset determined at act 610. The actuation command can cause a sprinkler 105 to actuate and release fire suppressant fluid 120. The actuation command can be provided to a sprinkler 105 disposed at a location above, or close to above, the detected event. For example, if the controller 210 determines the fire 225 is to the right of the detector 205 by fifteen feet (e.g., has an offset of fifteen feet to the right), the controller 210 can send an actuation command to a sprinkler 105 that is the closest to being disposed at a location fifteen feet to the right of the detector 205. The controller 210 can also send an actuation command to more than one sprinkler 105. For example, if the offset is fifteen feet to the right of the detector 205, and there is a first sprinkler 105 disposed ten feet to the right of the detector 205 and a second sprinkler 105 disposed twenty feet to the right of the detector 205, controller 210 can provide an actuation command to both the first and the second sprinklers 105.

The controller 210 can also, along with or instead of an actuation command, provide a hold command that can at least temporarily inhibit a sprinkler 105 from actuating. The hold command, for example, can be provided to a sprinkler 105 disposed at a location not above the detected event. For example, if the controller 210 determines the fire 225 is to the right of the detector 205 by fifteen feet, the controller 210 can send a hold command to a sprinkler 105 disposed to the left of the detector 205. The controller 210 can also send a hold command to more than one sprinkler 105. For example, if the controller 210 determines the fire 225 is to the right of the detector 205 by fifteen feet and there are multiple sprinklers 105 disposed to the left of the detector, the controller 210 can send a hold command to each sprinkler 105 disposed to the left of the detector 205. Responsive to receiving signals indicative of an active event, the controller 210 can send at least one of the hold command and the actuation command to a sprinkler 105 disposed in the space.

The controller 210 can also provide a hold command to a first sprinkler 105 disposed a first distance away from a detector 205 and can provide an actuation command to a second sprinkler 105 disposed a second distance away from the detector 205. For example, the first sprinkler 105 can be ten feet away from the detector 205 and the second sprinkler 105 can be twenty feet away from the detector 205. The controller 210 can send a hold command to the first sprinkler 105, which is closer to the detector 205, and can send an actuation command to the second sprinkler 105, which is farther way from the detector 205. The hold command can inhibit the first sprinkler 105 from actuating the full duration of the detected event, or the controller 210 can send a subsequent command (e.g., an actuation command) overriding the hold command.

Act 615 can also include bypassing the first sprinkler 105 and not providing a command to the first sprinkler. For example, with the first sprinkler 105 disposed the first distance away from the detector 205 and the second sprinkler 105 disposed the second distance away from the detector 205, with the second distance being longer than the first distance, the controller 210 can bypass the first sprinkler 105 and not provide the first sprinkler with a command. The controller 210 can send the only command, an actuation command, to the second sprinkler 105.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A fire protection system, comprising:
a controller communicably coupled with a detector, the controller to:
receive an input signal from the detector, the detector disposed at a location of a space, the input signal indicating an active hazard event;
determine a speed and a direction of an airflow in the space;
determine an offset for the active hazard event, the offset based on at least one of the speed and the direction of the airflow; and
provide an actuation command to a sprinkler based on the input signal received from the detector and based on the offset for the active hazard event.

2. The system of claim 1, comprising:
the detector is a first detector and the location of the space is a first location of the space;
the controller communicably coupled with a second detector, the controller to:
receive an input signal from the second detector, the second detector disposed at a second location of the space, the input signal from the second detector indicating the active hazard event; and
determine at least one of the speed and the direction of the airflow in the space based on at least one of the first location of the space relative to the second location of the space and a time between receipt of the input signal from the first detector and receipt of the input signal from the second detector.

3. The system of claim 1, comprising:
the sprinkler is a first sprinkler, the first sprinkler disposed a first distance away from the detector;
a second sprinkler disposed a second distance away from the detector, the second distance being longer than the first distance; and
the controller to bypass the first sprinkler disposed the first distance away from the detector and provide the actuation command to the second sprinkler disposed the second distance away from the detector.

4. The system of claim 1, comprising:
the sprinkler is a first sprinkler, the first sprinkler disposed a first distance away from the detector;
a second sprinkler disposed a second distance away from the detector, the second distance being longer than the first distance; and
the controller to provide a hold command to the first sprinkler disposed the first distance away from the detector and provide the actuation command to the second sprinkler disposed the second distance away from the detector, the hold command to at least temporarily inhibit the first sprinkler from actuating.

5. The system of claim 1, comprising:
the offset for the active hazard event defined by at least one of a distance away from the detector and a number of sprinklers away from the detector.

6. The system of claim 1, comprising:
the detector including an anemometer and the input signal indicating at least one of the speed and the direction of the airflow in the space.

7. The system of claim 1, comprising:
the offset for the active hazard is based on a ceiling height of the space.

8. The system of claim 1, comprising:
a plurality of detectors disposed in a grid pattern to monitor a storage structure for a fire;
the storage structure including at least one storage rack assembly; and
the grid pattern disposed beneath a ceiling of the space and above the storage structure.

9. The system of claim 1, comprising:
an electronically activated sprinkler system, the electronically activated sprinkler system including a plurality of sprinklers disposed in a grid pattern to protect a storage structure from a fire;
the storage structure including at least one storage rack assembly; and
the grid pattern disposed beneath a ceiling of the space and above the storage structure.

10. They system of claim 1, comprising:
a plurality of detectors disposed in a first grid pattern to monitor a storage structure for a fire; and
a plurality of sprinklers disposed in a second grid pattern to protect the storage structure from the fire, and
at least one of the plurality of detectors aligns axially with at least one of the plurality of sprinklers.

11. The system of claim 1, comprising:
the detector including at least one of a smoke sensor, a heat sensor, and an anemometer.

12. A fire protection method, comprising:
receiving, by a controller, an input signal from a detector, the detector disposed at a location of a space, the input signal indicating an active hazard event;
determining, by the controller, a speed and a direction of an airflow in the space;
determining, by the controller, an offset for the active hazard event, the offset based on at least one of the speed and the direction of the airflow; and
providing, by the controller, an actuation command to a sprinkler based on the input signal received from the detector and based on the offset for the active hazard event.

13. The method of claim 12, comprising:
the detector is a first detector and the location of the space is a first location of the space;
receiving, by the controller, an input signal from a second detector, the second detector disposed at a second location of the space, the input signal from the second detector indicating the active hazard event; and
determining, by the controller, at least one of the speed and the direction of the airflow in the space based on at least one of the first location of the space relative to the second location of the space and a time between receipt of the input signal from the first detector and receipt of the input signal from the second detector.

14. The method of claim 12, comprising:
the sprinkler is a first sprinkler, the first sprinkler disposed a first distance away from the detector;
bypassing, by the controller, the first sprinkler and not providing the first sprinkler with a command; and
providing, by the controller, a second sprinkler the actuation command, the second sprinkler disposed a second distance away from the detector, the second distance being longer than the first distance.

15. The method of claim 12, comprising:
the sprinkler is a first sprinkler, the first sprinkler disposed a first distance away from the detector;
providing, by the controller, a hold command to the first sprinkler disposed the first distance away from the detector, the hold command to at least temporarily inhibit the first sprinkler from actuating; and
providing, by the controller, an actuate command to a second sprinkler disposed a second distance away from the detector, the second distance being longer than the first distance.

16. The method of claim 12, comprising:
defining the offset for the active hazard event by at least one of a distance away from the detector and a number of sprinklers away from the detector.

17. The method of claim 12, comprising:
detecting, by the detector, at least one of the speed and the direction of the airflow in the space, the detector including an anemometer.

18. The method of claim 12, comprising:
installing a plurality of detectors, the plurality of detectors disposed in a grid pattern to monitor a storage structure;
the storage structure including at least one storage rack assembly; and
the grid pattern disposed beneath a ceiling of the space and above the storage structure.

19. The method of claim 12, comprising:
installing a plurality of detectors, the plurality of detectors disposed in a first grid pattern to monitor a storage structure for a fire; and
installing a plurality of sprinklers, the plurality of sprinklers disposed in a second grid pattern to protect the storage structure from the fire,
at least one of the plurality of detectors aligns axially with at least one of the plurality of sprinklers.

20. The method of claim 12, comprising:
the detector including at least one of a smoke sensor, a heat sensor, and an anemometer.
